(19) United States
(12) Patent Application Publication
(10) Pub. No.: US 2011/0276960 A1
(43) Pub. Date: Nov. 10, 2011

(54) IMAGE PROCESSING APPARATUS, WEB SERVER, INSTALLATION SYSTEM, INSTALLATION METHOD, AND PROGRAM

(75) Inventor: Hisashi Nakamoto, Yokohama-shi (JP)

(73) Assignee: CANON KABUSHIKI KAISHA, Tokyo (JP)

(21) Appl. No.: 13/093,717

(22) Filed: Apr. 25, 2011

(30) Foreign Application Priority Data
May 6, 2010 (JP) 2010-106638

(51) Int. Cl. G06F 9/445

(52) U.S. Cl. 717/178

(57) ABSTRACT

An image processing apparatus includes a downloading unit configured to download a plurality of software pieces from a distribution server, an installation unit configured to install software for the image processing apparatus that is included in the plurality of downloaded software pieces, and a transmission unit configured to transmit, to a web server, software for the web server that is included in the plurality of downloaded software pieces and setting data for performing operation tests of the software for the image processing apparatus and the software for the web server.

### BACKGROUND OF THE INVENTION

1. Field of the Invention

The present invention relates to a software delivery technology.

2. Description of the Related Art

It is known that an information processing apparatus such as a personal computer (PC) is connected to a web server on a network, and an operation screen provided by the web server is displayed on a web browser included in the information processing apparatus. In this case, the web browser of the information processing apparatus requests the web server to provide the operation screen. On the other hand, a web application on the web server transmits, in response to the request from the information processing apparatus, a HyperText Markup Language (HTML) file for causing the web browser to display the operation screen to the information processing apparatus.

The web browser of the information processing apparatus analyzes the received HTML file, and displays the operation screen based on a description of the received HTML file. Then, when a user inputs an instruction via the operation screen displayed on the web browser, the web browser notifies the web server of the input instruction. The web application on the web server that has received the notification executes processing according to the input instruction.

Recently, some of multifunction peripherals (MFP) equipped with scanners and printers include such web browsers. For example, Japanese Patent Application Laid-Open No. 2006-127503 discusses a technique for providing an operation screen for inputting instructions to utilize various functions of the MFP by the web server. More specifically, when a user inputs an instruction via the operation screen displayed by the web browser of the MFP, the web server that has received the notification requests the MFP to perform various processes according to a content of the instruction input by the user. In response to the request, the MFP executes requested processing. Thus, there is no need to store, in the MFP, all menu data for operating the MFP, and the menu data can be easily changed on the web server.

However, the conventional art has the following issues. In some of the information processing apparatuses such as MFPs, the web server provides a screen of a certain application and, in another application, a program stored in the MFP is read to be executed. Hereinafter, the application provided by the web server is referred to as a “web application”, and the application executed based on information stored beforehand in the MFP is referred to as a “native application”.

For example, there is a MFP in which a copy function is provided as a native application, and a scan function is provided as a web application. Even in this MFP, the user can have the same operability without being aware of which application is a web application and which application is a native application.

However, in an environment where the MFP cooperates with the web server, when a new function is added, a function must be added not only to the MFP side but also to the web server side. Similarly, in the case of updating an existing function, software of both of the MFP side and the web server side must be updated. As a result, much more time and labor are expended for installation or updating.

It can be expected that in the future when the environment of cooperation between the MFP and the web server comes into use among customers all over the world, manual installation or updating will be very difficult. Thus, at present, a remote updating mechanism needs to be invented.

### SUMMARY OF THE INVENTION

According to an aspect of the present invention, an image processing apparatus includes a downloading unit configured to download a plurality of software pieces from a distribution server, an installation unit configured to install software for the image processing apparatus that is included in the plurality of downloaded software pieces, and a transmission unit configured to transmit, to a web server, the installed software for the web server and setting data for performing operation tests of the software for the image processing apparatus and the software for the web server.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a system configuration of an information processing system.

FIG. 2 illustrates an example of a hardware configuration of each device included in the information processing system.

FIG. 3 illustrates an example of a functional configuration of each device and a distribution server included in the information processing system.

FIG. 4 is a flowchart illustrating an example of a processing procedure for requesting an operation screen to be displayed in a MFP.

FIG. 5 is a flowchart illustrating an example of a processing procedure of a web application that responds to the request of the operation screen.

FIG. 6 is a flowchart illustrating an example of a processing procedure of a service provider.

FIG. 7 illustrates software delivery processing (installation) in the information processing system.

FIG. 8 is a flowchart illustrating an example of an installation procedure of an installer.

FIG. 9 is a flowchart illustrating an example of an installation procedure of the web application.

FIG. 10 is a flowchart illustrating an operation test procedure of the web application.

FIG. 11 illustrates an example of a script file for setting.

### DESCRIPTION OF THE EMBODIMENTS

Various exemplary embodiments, features, and aspects of the invention will be described in detail below with reference to the drawings.

### <Hardware Configuration of Information Processing System>

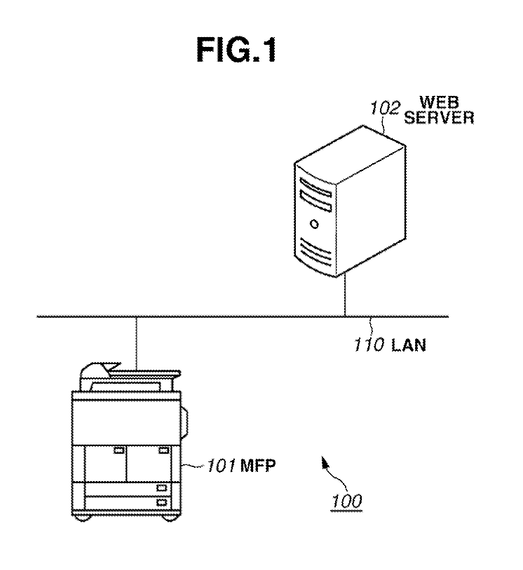

First, referring to FIG. 1, a hardware configuration of an information processing system 100 is described. FIG. 1 illustrates an example of a system configuration of the information processing system 100. The information processing system 100 includes a MFP 101 having a web browser function, and a web server 102 having a web server function. These devices are interconnected via a local area network (LAN) 110 to be able to communicate with each other. The information processing system 100 is an example of an installation system.

The MFP 101 is an example of an image processing apparatus. The MFP 101 includes a display unit configured to display a display screen of a web application provided from the web server 102 or a display screen of a native application stored beforehand in the MFP 101. The MFP 101 includes an operation unit equipped with a plurality of hardware keys (hereinafter, hard keys). The display unit for which a touch-panel liquid crystal display (LCD) is used, displays software keys and can receive inputs via the software keys. The web application is an example of a web service providing unit.

### <Control Configuration of Information Processing System>

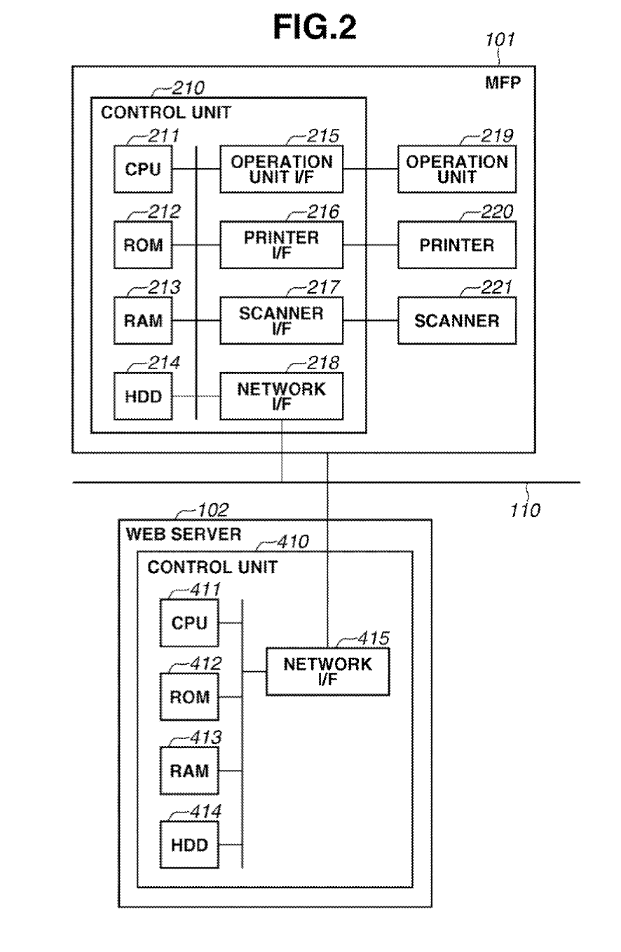

Next, referring to FIG. 2, a control configuration of the MFP 101 and the web server 102 is described. FIG. 2 illustrates an example of a hardware configuration of each device included in the information processing system 100.

A control unit 210 that includes a central processing unit (CPU) 211 is responsible for overall control of the MFP 101. The CPU 211 reads programs stored in a read-only memory (ROM) 212 to execute various control processes such as reading control and transmission control. A random access memory (RAM) 213 is used as a main memory for the CPU 211 or a temporary storage area such as a work area. A hard disk drive (HDD) 219 stores image data and various programs, or various information tables described below. An operation unit interface (I/F) 215 interconnects an operation unit 219 and a control unit 210. The operation unit 219 includes a liquid crystal display unit having a touch-panel function, or a keyboard.

The MFP 101 includes a web browser function described below. The web browser of the MFP 101 analyzes an HTML file received from the web server 102, and displays an operation screen based on a description of the received HTML file on the operation unit 219. The operation unit 219 includes a LCD display unit having a touch-panel sheet stuck to the LCD. The LCD display unit displays a native function module, the operation screen displayed by the web browser, and software keys, which are described below. When one of the displayed keys is pressed, position information indicating a pressed position is transmitted to the CPU 211.

The operation unit 219 has various hard keys including a start key, a stop key, a reset key, a guide key, a top menu key, and numerical keys. The start key is for instructing a start of a document image reading operation, and includes a two-color light-emitting diode (LED) display unit of green and red on its center. The two-color LED display unit indicates whether the start key is in a usable state by its color.

The stop key is for stopping an ongoing operation, and the reset key is used when setting is initialized. The guide key is for displaying a method of using the MFP 101. The top menu key is for displaying a top menu screen to select a function of the MFP 101. The numerical keys are used for inputting a numerical value.

A printer I/F 216 interconnects a printer 220 and the control unit 210. Image data to be printed by the printer 220 is transferred from the control unit 210 to the printer 220 via the printer I/F 216, and printed on a recording medium by the printer 220. A scanner I/F 217 interconnects a scanner 221 and the control unit 210. The scanner 221 reads an image on a document to generate image data, and inputs the image data to the control unit 210 via the scanner I/F 217. A network I/F 218 connects the control unit 210 to the LAN 210. The network I/F 218 transmits the image data or information to an external device (e.g., web server 102) on the LAN 110, or receives various pieces of information from the external device on the LAN 110.

The web server 102 includes a CPU 911 that is responsible for overall control of the web server 102. The CPU 411 reads programs stored in a ROM 412 to execute various control processes. A RAM 913 is used as a main memory for the CPU 411 or a temporary storage area such as a work area. An HDD 414 stores image data and various programs, or various information tables. A network I/F 415 connects a control unit 410 to the LAN 110. The network I/F 415 transfers various pieces of information with the other device on the LAN 110. A distribution server described below is similar in configuration to the web server 102.

The CPU (computer) 211 of the MFP 101 executes processing based on the programs stored in the HDD 219, thereby achieving functions of the MFP 101 described below, and processing of a flowchart in the MFP 101 described below. The CPU (computer) 411 of the web server 102 executes processing based on the programs stored in the HDD 414, thereby achieving functions of the web server 102 described below, and processing of a flowchart in the web server 102 described below. Similarly, a CPU of the distribution server executes processing based on programs stored in a HDD of the distribution server, thereby achieving functions of the distribution server described below.

### <Functional Configuration of Information Processing System>

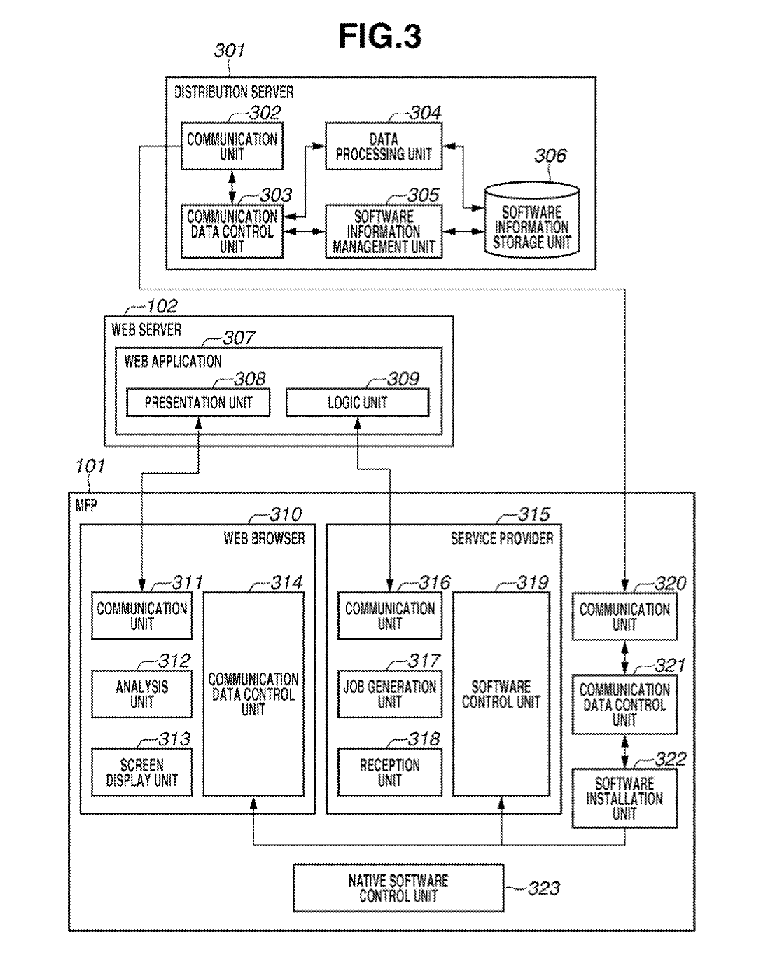

Next, referring to FIG. 3, a functional configuration of a distribution server 301 connected to the information processing system 100 through Internet is described.

FIG. 3 illustrates an example of a functional configuration of each device included in the information processing system 100 and the distribution server 301. Each functional block illustrated in FIG. 3 is achieved by executing a program by the CPU installed in each of the MFP 101, the web server 102, and the distribution server 301.

The MFP 101 includes, as functional components, a native software control unit 323, a web browser 310, a service provider 315, a communication unit 320, a communication data control unit 321, a software installation unit (installer) 322.

The native software control unit 323 indicates not functions provided by the web server 102 but various native applications provided based on the programs stored in the MFP 101. For example, the native applications include an application for executing printing by the printer 220 of the MFP 101, reading by the scanner 221, or transmission via the network I/F 218. A module for setting the entire MFP 101 or switching applications is also included in the native software control unit 323.

The web browser 310 includes, as functional components, a communication unit 311, an analysis unit 312, and a screen display unit 313. The communication unit 311 communicates with a presentation unit 308 of a web application 307 according to a hypertext transfer protocol (HTTP). More specifically, the communication unit 311 requests the web application 307 to provide an operation screen to be displayed by the web browser 310, or notifies the web application 307 of a user's instruction input via the operation screen displayed by the web browser 310.

The analysis unit 312 analyzes an HTML file received from the web application 307. The HTML file contains a description (screen information) indicating a content of the operation screen to be displayed by the web browser 310.

The screen display unit 313 displays the operation screen on the operation unit 219 based on a result of the analysis performed by the analysis unit 312. The operation screen thus displayed based on the screen information (HTML file) received from the web server 102 is referred to as a web browser screen.

The web server 102 includes the web application 307. The web application 307 includes a presentation unit 308 and a logic unit 309. The presentation unit 308 communicates with the communication unit 311, and transmits, to the MFP 101, the operation screen to be displayed by the web browser 310 of the MFP 101 in response to a request from the MFP 101. The presentation unit 308 receives, from the MFP 101, the user's instruction input via the operation screen displayed by the web browser 310 of the MFP 101.

The web application 307 that has received the user's instruction executes various processes according to instructed contents. According to the contents, the web application 307 requests the MFP 101 to execute processing. More specifically, the web application 307 requests execution of printing by the printer 220 of the MFP 101, reading by the scanner 221, or transmission via the network I/F 218.

The service provider 315 of the MFP 101 includes a communication unit 316, a job generation unit 317, and a reception unit 318. The communication unit 316 receives a processing request from the logic unit 309 of the web application 307. When a processing execution request is received from the web application 307, the job generation unit 317 generates a job for executing the requested processing to execute the job.

The communication unit 320 of the MFP 101 communicates with a communication unit 302 of the distribution server 301 to download software. The communication data control unit 321 controls the software received by the communication unit 320. The software installation unit 322 installs the software received by the communication unit 320. Hereinafter, the software installation unit 322 is referred to as an installer 322.

In the distribution server 301, the communication unit 302 communicates with the MFP 101 to download software. The communication data control unit 303 is responsible for transmitting or receiving data in communication of the MFP 101. A data processing unit 309 analyzes data from the communication data control snit 303. A software information management unit 305 manages data stored in a software information storage unit 306. The software information storage unit 306 stores software information for delivery.

### <Operation of Web Browser>

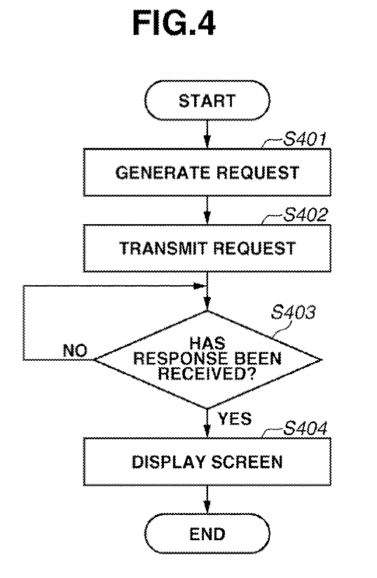

Referring to FIG. 4, requesting of an operation screen by the web browser 310 is described. FIG. 4 is a flowchart illustrating an example of a processing procedure of requesting the operation screen displayed by the MFP 101. The processing described below is executed by the web browser 310 which is achieved through execution of a program stored in the HDD 214 by the CPU 211 of the MFP 101.

In step S401, the web browser 310 generates a request asking the web server 102 to provide an operation screen to be displayed on the display unit of the MFP 101. The request may be a uniform resource locater (URL) preset as a webpage of the web browser 310, a URL input to a URL input section of the web browser 310 by a user, or a URL of a link selected by the user on a screen displayed by the web browser 310. In step S402, the web browser 310 transmits the generated request to the web server 102.

In step S403, the web browser 310 determines whether screen information of the operation screen has been transmitted as a response to the transmitted request from the web server 102. In reality, an HTML file is transmitted as the screen information to display the operation screen on the web browser 310 from the web server 102. After the web browser 310 has received the screen information of the operation screen (YES in step S403), the processing proceeds to step S409. When the screen information is not yet received (NO in step S403), the processing stands by until its reception. In step S404, the web browser 310 displays the operation screen on the display unit according to a description of the received HTML file.

### <Operation of Web Application>

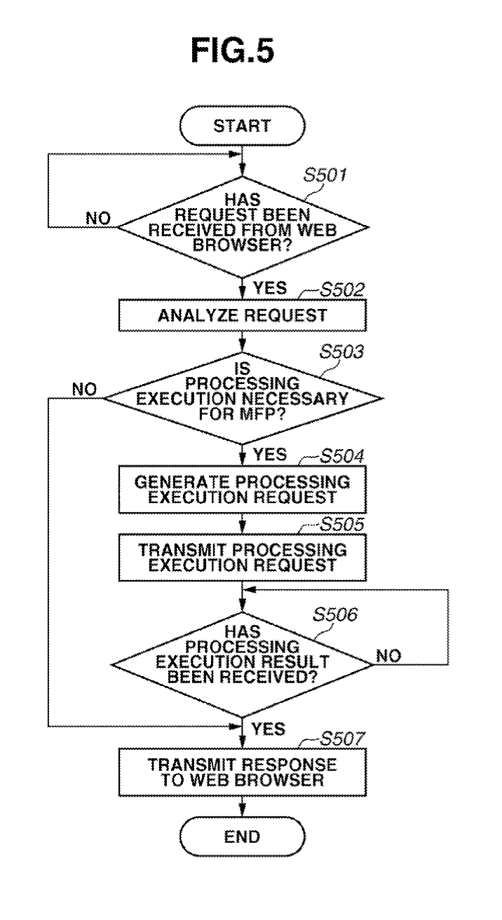

Next, referring to FIG. 5, a response made by the web server 102 to the request from the web browser 310 is described. FIG. 5 is a flowchart illustrating an example of a processing procedure of the web application 307 that responds to the request of the operation screen. The processing described below is executed by the web application 307, which is achieved through execution of a program stored in the HDD 414 by the CPU 411 of the web server 102.

In step S501, the web application 307 determines whether the request of the operation screen has been received from the web browser 310. When the request has been received (YES in step S501), the processing proceeds to step S502. When the request is not yet received (NO in step S501), the processing stands by until its reception. After the request has been received, in step S502, the web application 307 analyzes the received request. After the analysis, in step S503, the web application 307 determines whether processing execution is necessary for the MFP 101. When the web application 307 determines that the processing execution is necessary for the MFP 101 (YES in step S503), the processing proceeds to step S504. When not necessary (NO in step S503), the processing proceeds to step S507.

In step S504, the web application 307 generates a processing execution request for the MFP 101. In step S505, the web application 307 transmits the processing execution request to the MFP 101. In step S506, the web application 307 determines whether a processing result of the processing execution request has been received from the MFP 101. When the web application 307 determines that the processing result has been received (YES in step S506), the processing proceeds to step S507. When the processing result is not yet received (NO in step S506), the processing stands by until its reception.

In step S507, the web application 307 transmits a response to the web browser 310. In reality, this response becomes an HTML file to display the operation screen on the web browser 310 based on the request from the web browser 310.

### <Operation of Service Provider>

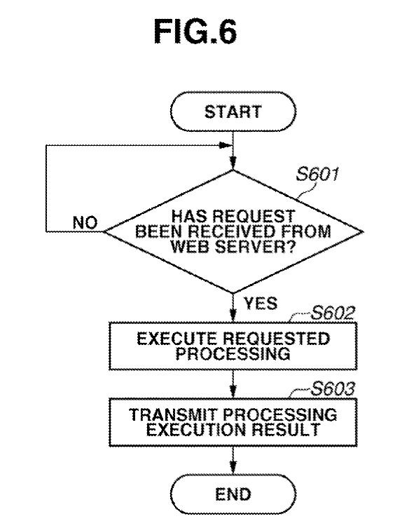

Next, referring to FIG. 6, processing of the service provider 315 of the MFP 101 is described. FIG. 6 is a flowchart illustrating an example of a processing procedure of the service provider 315. The processing described below is executed by the service provider 315, which is achieved through execution of a program stored in the HDD 214 by the CPU 211 of the MFP 101.

In step S601, the service provider 315 determines whether a request has been received from the web server 102. When the service provider 315 determines that the request has been received from the web server 102 (YES in step S601), the processing proceeds to step S602. When the request is not yet received (NO in step S601), the processing stands by until its reception.

In step S602, the service provider 315 executes processing according to a request content. The processing then proceeds to step S603. More specifically, the job generation unit 317 generates a job for executing the requested processing to execute the job. In step S603, the service provider 315 transmits a result of the processing execution to the web server 102.

### <Delivery of Software>

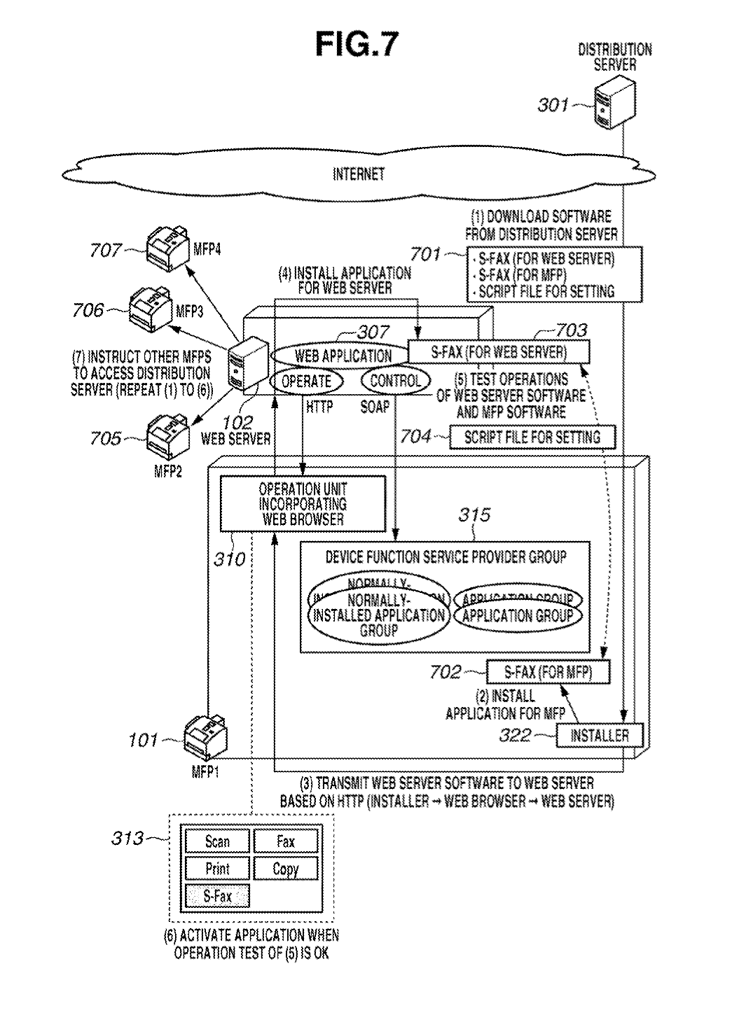

Next, referring to FIG. 7, delivery of software from the distribution server 301 to the MFP in the information processing system 100 is described. In this case, the distribution server 301 delivers software 701 for the MFP (image processing apparatus) and software 701 for the web server as a set. The distribution server 301 also delivers a script file for setting, in which an operation test content is described. The script file for setting is an example of data for setting.

First, the user displays a user interface (UI) of the installer 322 from the operation unit 219 of the MFP, and inputs a license access number of software to be downloaded from the distribution server 301. Then, the installer 322 requests the distribution server 301 to deliver new software (S-FAX) 701, and downloads the software from the distribution server 301. The S-FAX 701 as the current example of software includes software 702 for the MFP, software 703 for the web server, and a script file 704 for setting.

The installer 322 then installs the S-FAX (for MFP) 702 in the MFP. The installer 322 instructs the web browser 310 to transmit the S-FAX (for web server) 703 to the web server. The web browser 310 transmits the S-FAX (for web server) 703 to the web server by HTTP.

The web browser 310 has a plug-in for file transfer, so that the file can be transferred via the browser. In the web server 102, the web application 307 that is a communication destination with the web browser 310 installs the S-FAX (for web server) 703. The web application 307 activates the S-FAX (for web server) 703 according to the script file 704 for setting to perform an operation test with the S-FAX (for MFP) 702.

The web application 307 performs the operation test by referring to the script file 704 for setting. As an example of the test, a communication test is performed from the S-FAX (for web server) 703 to the S-FAX (for MFP) 702 by Simple Object Access Protocol (SOAP). In this case, the S-FAX (for web server) 703 transmits version information of the S-FAX (for web server) 703 to the S-FAX (for MFP) 702.

The S-FAX (for MFP) 702 determines whether the version information of the S-FAX (for web server) 703 is correct. When it is correct, the S-FAX (for MFP) 702 returns “OK” as a response.

The S-FAX (for web server) 703 then executes a next instruction of the script file 704 for setting. As an example, the S-FAX (for web server) 703 issues a facsimile (FAX) transmission instruction to the S-FAX (for MFP) 702, and transmits test data to an address for testing by FAX. When a response comes, the S-FAX (for web server) 703 confirms that the operation is “OK”.

When the operation test is OK, the web server 102 activates (validates) the S-FAX to display a menu of “S-FAX” on the screen display unit 313. Then, the web server 102 issues a software request instruction to the distribution server 301 to add a function to another image forming apparatus that the web server 102 itself manages.

### <Flow of MFP in Delivery of Software>

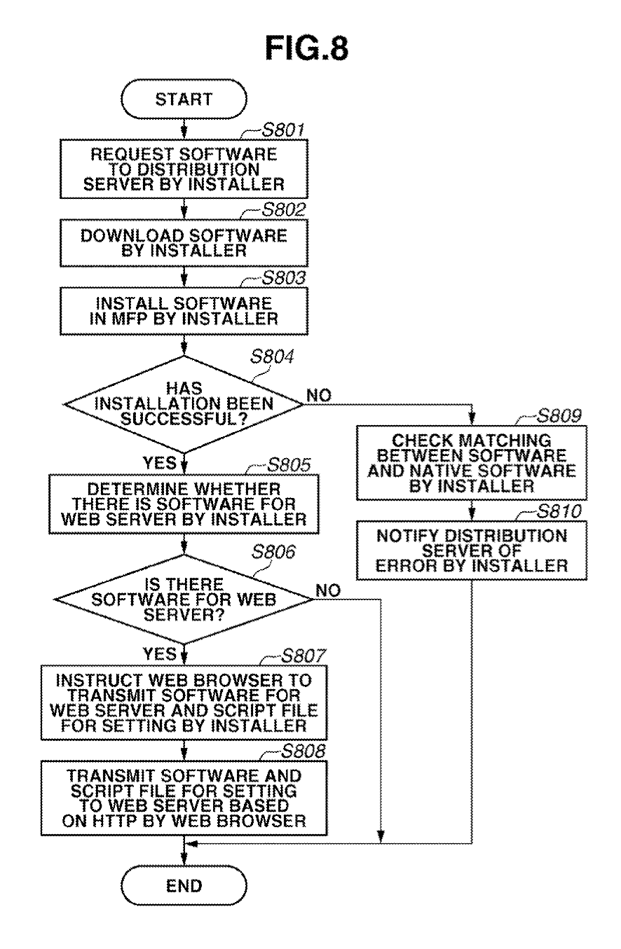

Next, referring to FIG. 8, processing of the installer 322 of the MFP 101 is described. FIG. 8 is a flowchart illustrating an example of an installation procedure of the installer 322. The processing described below is executed by the installer 322, which is achieved through execution of a program by the CPU 211 of the MFP 101.

In step S801, the installer 322 requests the distribution server 301 to provide software. In step S802, the installer 322 downloads the software. In step S803, the installer 322 installs MFP software (in the example illustrated in FIG. 7, S-FAX (for MFP)) included in the downloaded software in the MFP 101.

In step S804, whether the installer 322 has succeeded in installing the software is determined. When the installation is successful (YES in step S804), the processing proceeds to step S805. When unsuccessful (NO in step S804), the processing proceeds to step S809. In step S805, the installer 322 determines whether the downloaded software includes software for the web server 102.

In step S806, the installer 322 branches the processing based on the determination as to whether the downloaded software includes software for the web server 102 or not. When the installer 322 determines that the software for the web server 102 is included (YES in step S806), the processing proceeds to step S807. When the software for the web server 102 is not included (NO in step S806), the processing illustrated in FIG. 8 is ended.

In step S807, the installer 322 instructs the web browser 310 to transmit the software for the web server 102 and the script file 704 for setting to the web server 102. Instep S808, the web browser 310 transmits the software and the script file 704 for setting to the web server 102 by HTTP.

In step S809, the installer 322 checks matching between the software and the native software. More specifically, the installer 322 asks the native software control unit 323 about a version of the native software, and compares a version of the software with that of the native software to check matching therebetween.

In step S810, the installer 322 notifies the distribution server 301 of an error, and the processing illustrated in FIG. 8 is ended.

### <Flow of Web Server in Delivery of Software>

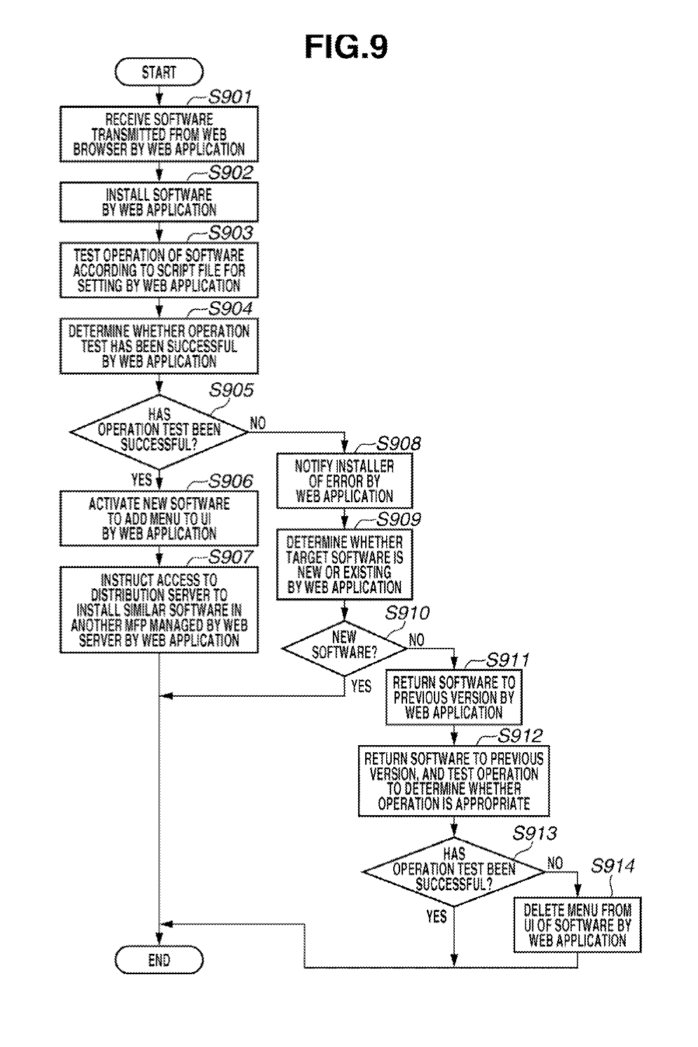

Next, referring to FIG. 9, processing of the web application 307 of the web server 102 is described. FIG. 9 is a flowchart illustrating an example of an installation procedure of the web application 307. The processing described below is executed by the web application 307, which is achieved through execution of a program stored in the HDD 414 by the CPU 411 of the web server 102.

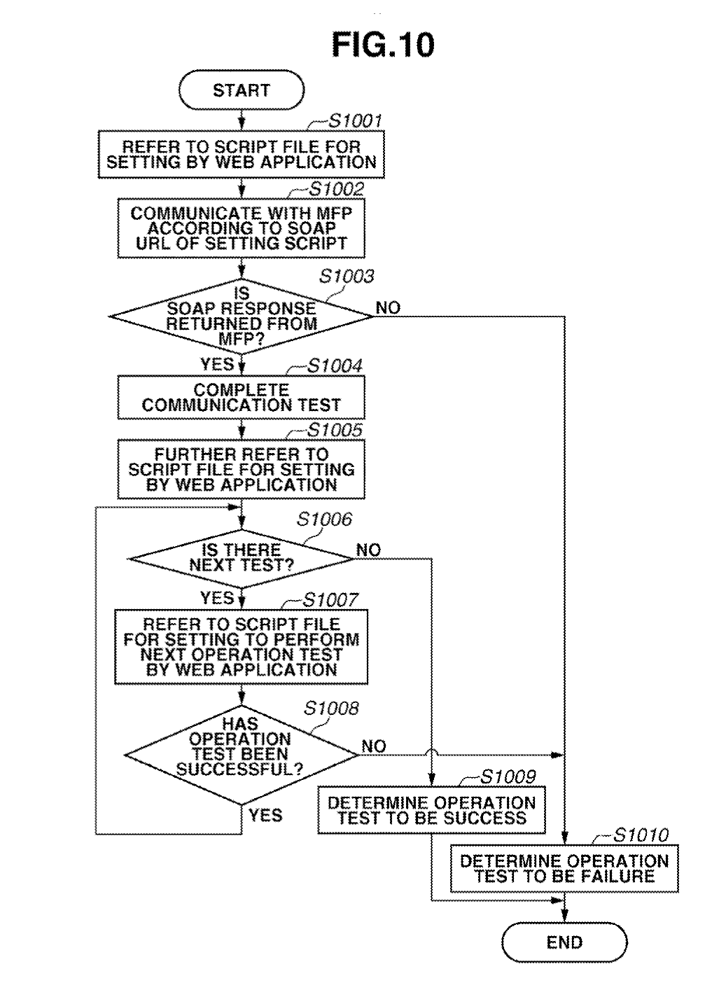

In step S901, the web application 307 receives software transmitted from the web browser 310. In step S902, the web application 307 installs the software. In step S903, the web application 307 performs an operation test of the software according to the script file 704 for setting. The processing in step S903 is described in detail below referring to FIG. 10.

In step S904, the web application 307 determines whether the operation test is successful. When the web application 307 determines that the operation test is successful (YES in step S905), the processing proceeds to step S906. When not successful (NO in step S905), the processing proceeds to step S907.

In step S906, the web application 307 activates installed new software to add a menu of the installed new software to the screen of the web browser 310 of the MFP 101.

In step S907, the web application 307 instructs another MFP managed by the web server 102 to access the distribution server 301 to install similar software.

In step S908, the web application 307 notifies the installer 322 of an error. In step S909, the web application 307 determines whether target software is new or already existing one. When the web application 307 determines that the software is new (YES in step S910), the processing illustrated in FIG. 9 is ended. When the software is existing one (NO in step S910), the processing proceeds to step S911.

In step S911, the web application 307 returns the software to a previous version that has been checked for operation. In step S912, the web application 307 performs an operation test to determine whether the software returned to the previous version appropriately operates.

When the operation test is successful (YES in step S913), the processing illustrated in FIG. 9 is ended. When not successful (NO in step S913), the processing proceeds to step S914.

In step S914, the web application 307 deletes the menu of the existing software from the screen of the web browser 310 of the MFP 101, so that a function inappropriate in operation can be prevented from being provided.

### <Flow of Operation Test in Delivery of Software>

Next, referring to FIG. 10, an operation test performed by the web application 307 by referring to the script file 704 for setting is described. FIG. 10 is a flowchart illustrating an example of an operation test procedure of the web application 307. The processing described below is executed by the web application 307, which is achieved through execution of a program stored in the HDD 414 by the CPU 411 of the web server 102.

In step S1001, the web application 307 refers to the script file 704 for setting. In step S1002, the web application 307 communicates with the service provider 315 of the MFP according to the SOAP URL of the script file 704 for setting.

In step S1003, when a SOAP response comes from the service provider 315 of the MFP (YES in step S1003), the processing proceeds to step S1004. When no response comes (NO in step S1003), the processing proceeds to step S1010. Instep S1004, the web application 307 completes the communication test.

In step S1005, the web application 307 further refers to the script file 704 for setting. In step S1006, when the web application 307 determines that there is a next test (YES in step S1006), the processing proceeds to step S1007. When there is no next test, the processing proceeds to step S1009.

In step S1007, the web application 307 refers to the script file 704 for setting to perform the next operation test. In step S1008, when the web application 307 determines that the operation test is successful (YES in step S1008), the processing returns to step S1006. When not successful (NO in step S1008), the processing proceeds to step S1010.

In step S1009, the web application 307 determines that the operation test is successful. In step S1010, the web application 307 determines that the operation test is a failure.

### <Script File for Setting>

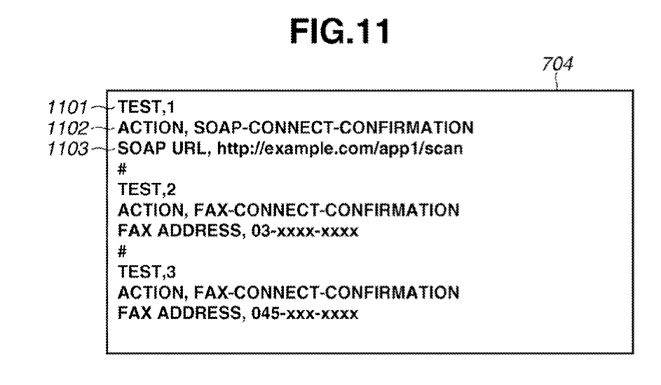

Next, referring to FIG. 11, the script file 704 for setting is described. FIG. 11 illustrates an example of the script file 704 for setting. In the example illustrated in FIG. 11, the script file 704 for setting is described as a comma-separated-value (CSV) file. A TEST tag 1101 indicates what number a test is.

An ACTION tag 1102 indicates what test is performed. In this case, the ACTION tag 1102 is SOAP-CONNECT-CONFIRMATION, indicating that a SOAP communication test is performed. Information 1103 is for performing the communication test indicated by the ACTION tag 1102.

The ACTION tag 1102 indicates that the SOAP communication test is performed. Thus, by writing SOAP URL in a tag 1104 and accessing its address, the SOAP communication test is performed. The script file for setting is separately defined so that the web application 307 can recognize it.

According to the above described exemplary embodiment, in the environment where the MFP cooperates with the web server, when a new function is added, applications of the web server side and the MFP side can be easily installed. The processing includes even the operation checking, and thus setting work of the applications on the web server side and the MFP side can be eliminated.

Even if there are many MFPs in the environment, this case can be dealt with, since the MFP managed by the web server itself is instructed to acquire an application from the distribution server. In other words, in the environment where the image processing apparatus cooperates with the web server, software can be automatically and appropriately delivered according to the above described exemplary embodiment.

The present invention can also be realized by executing the following process. That is, a process in which a software (program) that realizes the functions of the above-described embodiments is supplied to the system or apparatus via a network or a recording medium of various types, and then a computer of the system or apparatus (or devices such as CPU or MPU) reads out the program and executes it. In such a case, the recording medium where the program is stored as well as the program are included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-106638 filed May 6, 2010, which is hereby incorporated by reference herein in its entirety.

What is claimed is:

1. An image processing apparatus comprising:
a downloading unit configured to download a plurality of software pieces from a distribution server;
an installation unit configured to install software for the image processing apparatus that is included in the plurality of downloaded software pieces; and
a transmission unit configured to transmit, to a web server, software for the web server that is included in the plurality of downloaded software pieces and setting data for performing operation tests of the software for the image processing apparatus and the software for the web server.

2. The image processing apparatus according to claim 1, further comprising a web browser configured to communicate with the web server,
wherein the transmission unit transmits the software for the web server and the setting data to the web server via the web browser.

3. A web server capable of providing web services, the web server comprising:
a reception unit configured to receive, from an image processing apparatus, software for the web server and setting data for performing operation tests of software for the image processing apparatus that is installed in the image processing apparatus and the software for the web server; and
an installation unit configured to install the received software for the web server,
wherein the operation tests of the software for the image processing apparatus and the installed software for the web server are performed according to the received setting data.

4. The web server according to claim 3,
wherein if the operation tests are successful, the software for the web server that has been installed in the web server is validated; and
a menu of the software for the web server is added as one of the web services to a screen of a web browser of the image processing apparatus.

5. The web server according to claim 3, further comprising an instruction unit configured to instruct, if the operation tests are successful, an image processing apparatus different from the image processing apparatus managed by the web server to access a distribution server that delivers software for the image processing apparatus.

6. An installation system comprising:
an image processing apparatus; and
a web server configured to provide web services,
wherein the image processing apparatus includes:
a downloading unit configured to download a plurality of software pieces from a distribution server;
an installation unit configured to install software for the image processing apparatus that is included in the plurality of downloaded software pieces; and
a transmission unit configured to transmit, to a web server, software for the web server that is included in the plurality of downloaded software pieces and setting data for performing operation tests of the software for the image processing apparatus and the software for the web server, and
wherein the web server includes:
a reception unit configured to receive the software for the web server and the setting data from the image processing apparatus; and
an installation unit configured to install the received software for the web server,
wherein the operation tests of the software for the image processing apparatus and the installed software for the web server are performed according to the received setting data.

7. The installation system according to claim 6, wherein the image processing apparatus further comprises a web browser configured to communicate with the web server,
wherein the transmission unit transmits the software for the web server and the setting data to the web server via the web browser.

8. The installation system according to claim 6,
wherein if the operation tests are successful, the software for the web server that has been installed in the web server is validated; and
a menu of the software for the web server is added as one of the web services to a screen of a web browser included in the image processing apparatus.

9. The installation system according to claim 6, wherein the web server further includes an instruction unit configured to instruct, if the operation tests are successful, an image processing apparatus different from the image processing apparatus managed by the web server to access a distribution server that delivers software for the image processing apparatus.

10. A method for installing software in an image processing apparatus, the method comprising:
downloading a plurality of software pieces from a distribution server;
installing software for the image processing apparatus that is included in the plurality of downloaded software pieces; and
transmitting, to a web server, software for the web server that is included in the plurality of downloaded software pieces and setting data for performing operation tests of the software for the image processing apparatus and the software for the web server.

11. The method according to claim according to claim 10, further comprising:
communicating with the web server by a web browser; and
transmitting the software for the web server and the setting data to the web server via the web browser.

12. A method for installing software in a web server, the method comprising:
receiving, from an image processing apparatus, software for the web server and setting data for performing operation tests of software for the image processing apparatus that is installed in the image processing apparatus and the software for the web server;
installing the received software for the web server; and
performing the operation tests of the software for the image processing apparatus and the installed software for the web server according to the received setting data.

13. The method according to claim 12, if the operation tests are successful, further comprising:
validating the software for the web server; and
adding a menu of the software for the web server as one of the web services to a screen of a web browser of the image processing apparatus.

14. The method according to claim 12, further comprising instructing, if the operation tests are successful, an image processing apparatus different from the image processing apparatus managed by the web server to access a distribution server that delivers software for the image processing apparatus.

15. A computer readable storage medium on which is stored computer program for making a computer execute a method for installing software in an image processing apparatus, the method comprising:
downloading a plurality of software pieces from a distribution server;
installing software for the image processing apparatus that is included in the plurality of downloaded software pieces; and
transmitting, to a web server, software for the web server that is included in the plurality of downloaded software pieces and setting data for performing operation tests of the software for the image processing apparatus and the software for the web server.

16. The computer readable storage medium according to claim according to claim 15, further comprising:
communicating with the web server by a web browser; and
transmitting the software for the web server and the setting data to the web server via the web browser.

17. A computer readable storage medium on which is stored a computer program for making a computer execute a method for installing software in a web server, the method comprising:
receiving, from an image processing apparatus, software for the web server and setting data for performing operation tests of software for the image processing apparatus that is installed in the image processing apparatus and the software for the web server;
installing the received software for the web server; and
performing the operation tests of the software for the image processing apparatus and the installed software for the web server according to the received setting data.

18. The computer readable storage medium according to claim 17, if the operation tests are successful, further comprising:
validating the installed software for the web server; and
adding a menu of the software for the web server as one of the web services to a screen of a web browser of the image processing apparatus.

19. The computer readable storage medium according to claim 17, further comprising instructing, if the operation tests are successful, an image processing apparatus different from the image processing apparatus managed by the web server to access a distribution server that delivers software for the image processing apparatus.
